(19) United States
(12) Patent Application Publication
(10) Pub. No.: US 2018/0167223 A1
(43) Pub. Date: Jun. 14, 2018

(54) APPARATUS AND METHOD FOR ROBUST POWERED ETHERNET NETWORKS

(71) Applicants: Rana J. Pratap, San Jose, CA (US); Jo S. Major, Cupertino, CA (US); Bradley D. Gaiser, Los Altos, CA (US)

(72) Inventors: Rana J. Pratap, San Jose, CA (US); Jo S. Major, Cupertino, CA (US); Bradley D. Gaiser, Los Altos, CA (US)

(21) Appl. No.: 15/836,662

(22) Filed: Dec. 8, 2017

Related U.S. Application Data
(60) Provisional application No. 62/432,322, filed on Dec. 9, 2016.

(51) Int. Cl. H04L 12/10; G06F 1/26

(52) U.S. Cl. CPC H04L 12/10; G06F 1/266

(57) ABSTRACT

A network device provides a plurality of user configurable and controllable ports for supporting one or more powered devices and one or more power sources on a network, via a unique “n” port switch or similar hardware device. The network device disclosed herein allows each of the network ports to be functionally interchangeable in multiple application environments. Controller circuits and a logic unit or logic controller automatically detect changes on the ports and reconfigure voltage and/or data paths so that the external devices connected to the switch continue to be able to communicate and provide or consume power. Since all ports function in a substantially identical manner, there is no need to label the ports as either inputs or outputs, where an input port would be connected to a provider of POE power and an output would be a consumer of POE power.

### BACKGROUND OF THE INVENTION

### 1. Technical Field

The present invention relates to the field of power and data cabling and more specifically relates to cabling equipment for delivering power and data for certain applications using multiple sensors.

### 2. Background Art

In traditional Ethernet-networked sensor installations, a cable must generally be run from a centralized switch to each sensor in the network. Applications using multiple sensors, such as a security/monitoring system using multiple surveillance cameras, Ethernet-enabled thermostats, etc., will typically require multiple long cable runs of category 5 or category 7 cables. The use of relatively expensive cables to cover long distances can result in significant labor and material costs in the form of cabling, conduit, cable trays, etc.

Another aspect of installing multiple sensors is the availability of power at each sensor. For example, a surveillance camera placed on the outside of a building may not have a power drop nearby to provide the electrical power needed to operate the camera. In recent years, this problem has been partly solved by using Power Over Ethernet (“POE”) switches that can be configured to provide power via data cables. This power delivery system has resulted in the manufacture of sensors, such as the surveillance camera mentioned, that receive power via the Ethernet cabling, obviating the need for a nearby power drop.

FIG. 1 illustrates a prior art network environment where several powered devices (PDs) are powered by an Ethernet switch acting as a power source (PSE). In such a network, the PSE actively probes the devices (PDs or other non-PD Ethernet devices) on the other end of an Ethernet cable to determine whether it is safe to apply voltage (typically ˜48V) to the cable. Those skilled in the art will recognize that a non-PD Ethernet device may be damaged or destroyed if POE voltage is applied to the non-PD Ethernet device. As a consequence, the PSE does not apply voltage to the Ethernet cable unless the device on the other end responds correctly to the signals applied by the PSE during startup. This is a “handshake” process to ensure that POE is supplied only to devices that are configured to receive the supplied voltage.

Powering devices using POE has solved the power problem for some applications, but has not provided a complete solution for additional difficulties associated with running Ethernet cables to each sensor. For example, additional problems include excessive power dissipation in the room or closet where the POE switch sits, installation costs, lack of redundancy in the data path, and lack of redundancy in the power supply for the network and associated devices. Accordingly, without additional improvements to the state of the art for POE devices, the performance and flexibility of POE networks will continue to be suboptimal.

### SUMMARY OF THE INVENTION

The present invention comprises a network device that is powered by a PSE switch or a POE power injector on an Ethernet port where the network device is configured to apply power to its other output ports where those other output ports act as PSE devices relative to other such devices or attached POE sensors. This approach facilitates the full safety of the PSE/PD handshake specified by the IEEE POE standard, thereby reducing or preventing hardware damage that is possible if the wrong types of devices are connected to the network or in situations where a person was to come into contact with the current carrying conductors of a connected and powered Ethernet cable.

In addition, the network device of the present invention most preferably incorporates an N-port switch circuit that allows the data carried by the POE Ethernet cable to flow from one port of the network device to the other ports on the network device. The N-port switch most preferably manages Ethernet traffic through the network device, in particular, handling data packet collisions that can occur when multiple devices on the network send data messages at the same time.

One aspect of the most preferred embodiments of the present invention is that the plurality of ports on the network device are completely interchangeable from a functionality standpoint. For purposes of this disclosure, this port interchangeability function is referred to as “omni-dexterous.” Specifically, any port on the network device can be configured to function as an input port, an output port, or a device port. The most preferred embodiments of the present invention comprise hardware and embedded logic configured to: (i) ascertain which ports should accept input power; (ii) ascertain which ports should be prevented from accepting power; and (iii) apply the incoming power signal to the proper ports as required for the specific application environment. Consequently, installation of multiple devices in a network is relatively simple and not generally subject to typical installation errors that often result if input ports were inadvertently connected to other input ports, output ports were inadvertently connected to other output ports, and so on.

Another preferred embodiment of the present invention provides a network device that can be configured to support a daisy-chain network topology, typically resulting in a dramatic reduction in the overall length of cabling needed for the more traditional star network topology. Shorter cable runs will often result in both lower material costs and less labor costs in installing a system, as well as a more robust network signal for enhanced data communication and speed.

In some preferred embodiments of the present invention, the network device may be incorporated into networks using a ring or mesh topology. With standard low-end Ethernet devices, a ring or mesh network topology is generally avoided because it may result in multiple paths for data transmission and typically slows network traffic due to data packets collisions. The most preferred embodiments of the network device of the present invention incorporates internal logic, typically implemented by a processor or microcontroller unit (MCU or “logic unit”) that communicates with other devices on the network. The ports of the network device may be programmatically configured by the logic unit to strategically disable one or more ports so that any desired data source or destination is accessible on the network, but no redundant network paths exist where the same data packet is able to reach a destination node via two different routes.

Fault-tolerance is obtained by being able to dynamically reconfigure both the data and power routing of all ports when device failures or disconnected or cut wires result in an existing route no longer being available. In addition, one or more of the network devices arranged in a ring or mesh topology could be connected to a different Ethernet switch, resulting in redundant data paths back to networked servers, allowing for all devices to continue operation even after wires are disconnected or cut. In addition, power redundancy and the associated full fault-tolerance can be achieved by connecting multiple network devices to the network to power injectors or to other POE Ethernet switches. Note that these power injectors and POE Ethernet Switches can be configured to be on separate circuit breakers and can potentially be supplied through an uninterruptible power supplies (UPS), resulting in an even more robust network where power failure and brown outs are less likely to disrupt data transmission and overall network performance.

In some preferred embodiments of the present invention, one or more external power sources are provided to allow supplemental power to be applied to the network resulting in enhanced power capacity and source redundancy. This is a significant improve over prior art devices where power is supplied from a single POE Ethernet Switch.

In some preferred embodiments of the present invention, power can be tapped off of the incoming POE power supply, converted to a lower voltage, and provided through an external connector to auxiliary devices at standard voltage levels. Typical voltage levels that may be supplied from this arrangement include, but are not limited to, 1.8V, 3.3V, 5V, 12V, 24V, and 48V.

In some preferred embodiments of the present invention, the network device disclosed herein can be packaged with various sensors, thereby allowing these sensors to be Ethernet enabled and accruing all the fault-tolerant advantages of the stand-alone version of the network switch. Examples of devices that might benefit from this unique capability include, but are not limited to, RFID readers, surveillance cameras, industrial light stacks, and motion detectors.

### BRIEF DESCRIPTION OF THE DRAWINGS

The preferred embodiments of the present invention will hereinafter be described in conjunction with the appended drawings, wherein like designations denote like elements, and:

FIG. 1 is a block diagram of a conventional (prior art) network with network devices being arranged in a star topology;

FIG. 2 is a schematic block diagram of a transformer (prior art) configured to separate data from the incoming POE (e.g., power+data) signal;

FIG. 3 is a schematic block diagram of a transformer (prior art) that is configured to add power to the data stream resulting in an outgoing POE (e.g., power+data) signal;

FIG. 4 is a block diagram of a network of POE network devices (prior art) arranged in a star topology;

FIG. 5 is a schematic block diagram of a POE/PSE device (prior art) connected via an Ethernet cable to a POE/PD device;

FIG. 6A is a block diagrams of a network of POE sensors arranged in a star topology using a network device in accordance with a preferred embodiment of the present invention;

FIG. 6B is a network of POE sensors arranged in a daisy-chain topology using a network device in accordance with a preferred embodiment of the present invention;

FIG. 7 is a block diagram of a 3-port POE network device suitable for use in a network in accordance with a preferred embodiment of the present invention;

FIG. 8 is a block diagram of a network of POE devices arranged in a ring topology using a network device in accordance with a preferred embodiment of the present invention; and

FIG. 9 is a block diagram of a network of POE devices arranged in a ring topology with a redundant data connection and a redundant power input coupled to an external power source and a POE power injector in accordance with a preferred embodiment of the present invention.

### DETAILED DESCRIPTION OF THE PREFERRED EMBODIMENTS

A network device provides a plurality of user configurable and controllable ports for supporting one or more powered devices and one or more power sources on a network, via a unique “n” port switch or similar hardware device. The network device disclosed herein allows each of the network ports to be functionally interchangeable in multiple application environments. Controller circuits and a logic unit automatically detect changes on the ports and reconfigure voltage and/or data paths so that the external devices connected to the switch continue to be able to communicate and provide or consume power. Since all ports function in a substantially identical manner, there is no need to label the ports as either input ports or output ports, where an input port would be connected to a provider of POE power and an output would be a consumer of POE power.

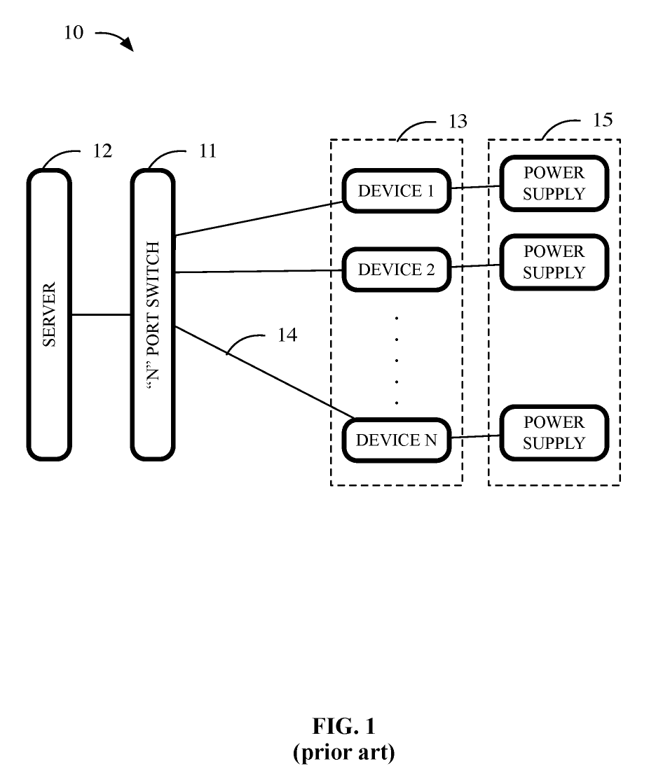

FIG. 1 through FIG. 5 illustrate cases of previously known solutions that can be used to provide context for better understanding the invention disclosed herein.

Referring now to FIG. 1, a common prior art implementation of an Ethernet network 10 is illustrated. Ethernet network 10 includes a network switch 11, a server 12, and a plurality of network devices or clients 13 connected to each other through a plurality of Ethernet cables 14 in a typical star configuration or topology.

The star network of FIG. 1 is typically used to set up the communications networks for many modern Ethernet-based networks. A server 12, or one of the devices 13, sends a message to one or more devices on network 10 based on the address or other identification schema used to identify devices 13. Network switch 11 represents any typical “n” port switch and typically uses the hardware address of each message to determine an optimal route to the specific device 13 to which the message is addressed.

In some Ethernet networking applications, it is difficult to provide power to some of the devices on the network. In FIG. 1, for example, in most standard networking configurations, each of switch 11, server 12, and devices 13 must be connected to a power source in order to provide electrical power to the device. This usually means running an electrical cable or cord to each device.

Solving this problem has resulted in the advent of a new set of devices and networking standards for delivering the power to the devices through the Ethernet cables. The general designation for the delivery of power through Ethernet cables is Power Over Ethernet (POE). The IEEE has a set of standards for how much power can be carried through a POE enabled network segment and the protocols that POE enabled networking hardware should incorporate to safely and reliably connect.

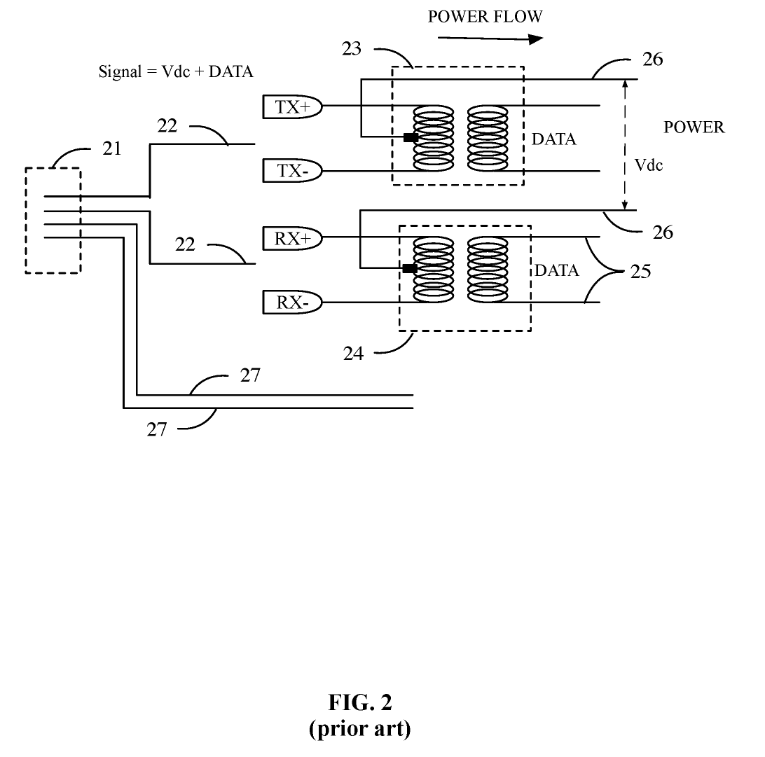

Referring now to FIG. 2, a prior art solution for separating the data signal from the power signal on an incoming POE power+data stream provided by an Ethernet cable is illustrated. This consists of the 2 pairs of wires of an incoming Ethernet cable 22, a pair of transformers for separating the data from the power 23 and 24, the 2 pairs of outgoing wires carrying the Ethernet data 25, the pair of wires carrying the outgoing power 26, and the extra 2 pairs of wires in the incoming Ethernet cable 27. This configuration shows a POE configuration that only uses 2 of the 4 pairs of wires within the Ethernet cable. All discussions within this document can apply equally to POE configurations that use just the extra two pairs of wires to supply the POE power as well as configurations where all 4 pairs carry power improving the power delivery capability of the system.

The transformers 23 and 24 couple the alternating current (AC) component of the incoming signal carried on two pairs of wires 22 in the Ethernet cable connected to the input side of the transformer to the pairs of wires 25 connected to the output side of the transformer, but do not pass any of the direct current (DC) component. The center tap of transformer 23 accesses the incoming DC current from the power source and provides a return path back to the current's source via the center tap of transformer 24. Those skilled in the art will recognize that the power supplied via a POE network is DC and the Ethernet data is a relatively high frequency AC signal. Consequently, this type of transformer setup quite effectively separates the power 26 from the data 25.

In some applications of POE, the power is carried on the extra 2 pairs of wires. In this configuration, an additional pair of center-tapped transformers is typically used to tap the DC power.

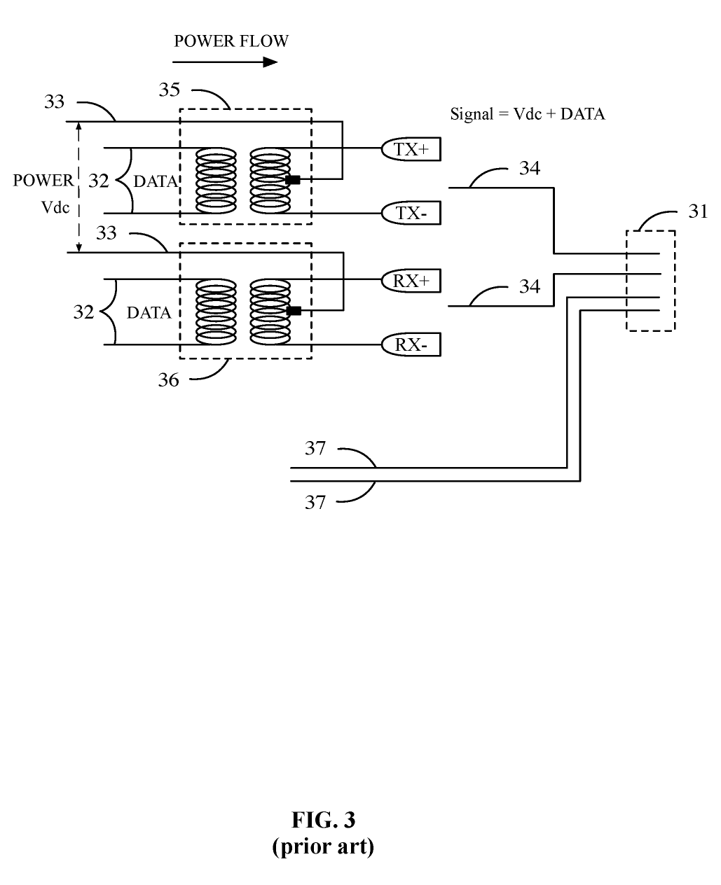

FIG. 3 illustrates the addition of power to the data stream resulting in an outgoing power+data stream on an outgoing Ethernet cable 31. This consists of the 2 pairs of wires 32 carrying the data to be output on the Ethernet cable 34, a pair of wires 33 carrying the power to be added to the outgoing Ethernet cable 34, a pair of transformers 35 and 36 and an extra pair of wires 37 that complete the 4 pairs of wires that comprise a standard Ethernet cable.

The transformers 35 and 36 couple the AC Ethernet data signal carried on the two pairs of wires 32 to the output side of the transformer placing that signal on the connected wires 34. Similarly, the DC voltage is applied to the connected wires 34 by injecting the voltage to be added via the pair of wires 33 connected to the center taps of the transformers. In addition, in some applications, the power is carried on the extra pair of wires 37 in which case, power from wires 33 is injected via another pair of transformers (not shown) onto the extra pair 37.

Note that the circuit shown in FIG. 1 is substantially a mirror image of the circuit shown in FIG. 2. This symmetry provides one of the properties that enables the ports on this invention to be fully interchangeable with one another. This property will be discussed in more detail below.

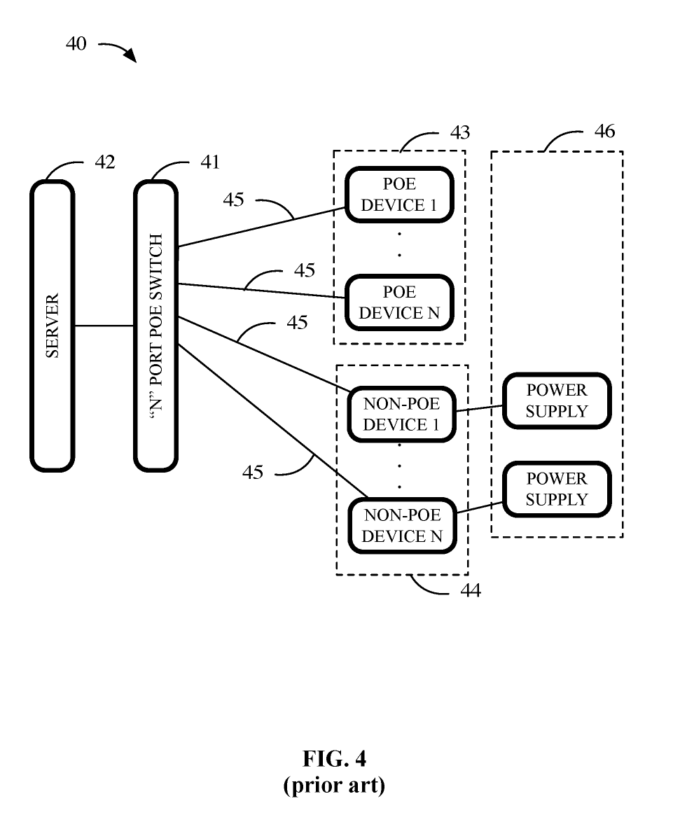

FIG. 4 illustrates a POE enabled Ethernet network 40. The POE Ethernet network 40 includes a POE network switch 41, a server 42, a plurality of POE network devices 43, and a plurality of non-POE network devices 44 connected to each other through Ethernet cables 45 in a typical star configuration.

Roles of the POE network switch 41, the server 42, and the network clients 43 and 44 are the same as described above. The primary difference is that now the POE network switch 41 delivers power to the POE network clients 43 via the connecting Ethernet cables 45. As a consequence, The POE network devices 43 do not need to have standard power cords to supply the power needed to run the electronics in those devices.

The non-POE network devices 44, however, obtain their power through standard power cords. Generally, these non-POE network devices do not expect voltage to be applied to their Ethernet connectors. Consequently, if POE voltage were to be applied to these devices, there is a good chance that it would cause harm to these devices possibly even destroying their electronics. To help prevent this problem, the IEEE 802.3 standards specify voltage levels for specific hardware handshakes that take place between Power Source Equipment (PSEs) that provide power and Powered Devices (PDs) that consume power. In FIG. 4, the POE network switch 41 is a PSE and the POE network clients 43 are PDs.

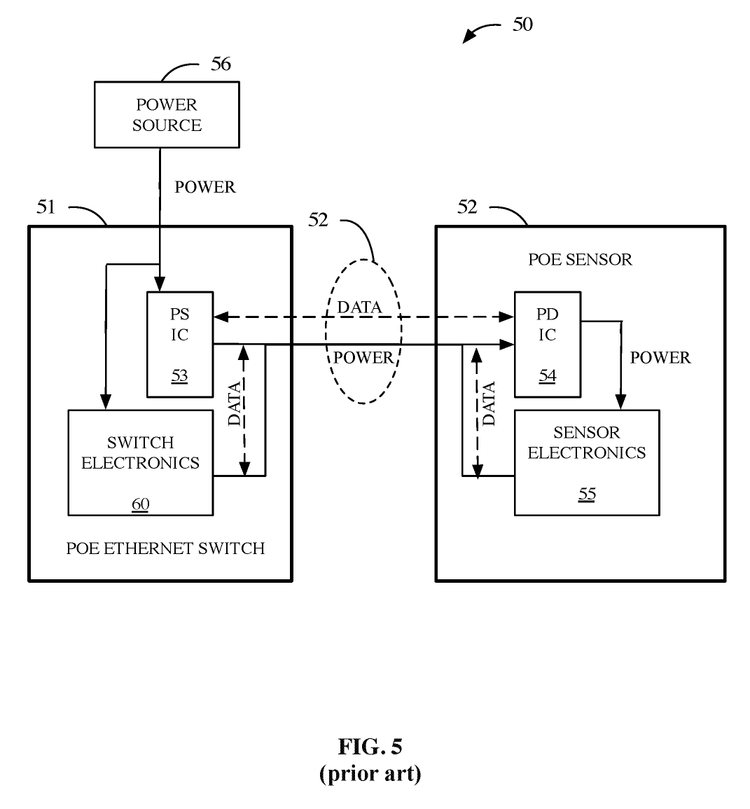

FIG. 5 illustrates the role of PSE integrated circuits (ICs) in network equipment in the form of a POE Ethernet Switch 51 that sources power and PD ICs in a network device in the form of a POE Sensor 52 that utilizes the POE power to drive the sensor's internal electronics. The PSE IC 53 takes power from an external source 56 and injects that power onto the Ethernet cable 57. In addition, the internal Switch Electronics 60 places the data 59 onto the Ethernet cable 57. On the POE sensor 52 side, the data and power are separated by a transformer circuit like the one shown in FIG. 2. The data 59 is forwarded on to the internal Sensor Electronics 55 and the power is provided to the Sensor Electronics 55 through the PD IC 54.

Note that the PSE IC 53 interfaces through the Ethernet cable 57 to the PD IC 54. This electrical path allows the PSE IC to interact with the PD IC to determine that it is safe for the PSE to apply the POE power to the Ethernet cable.

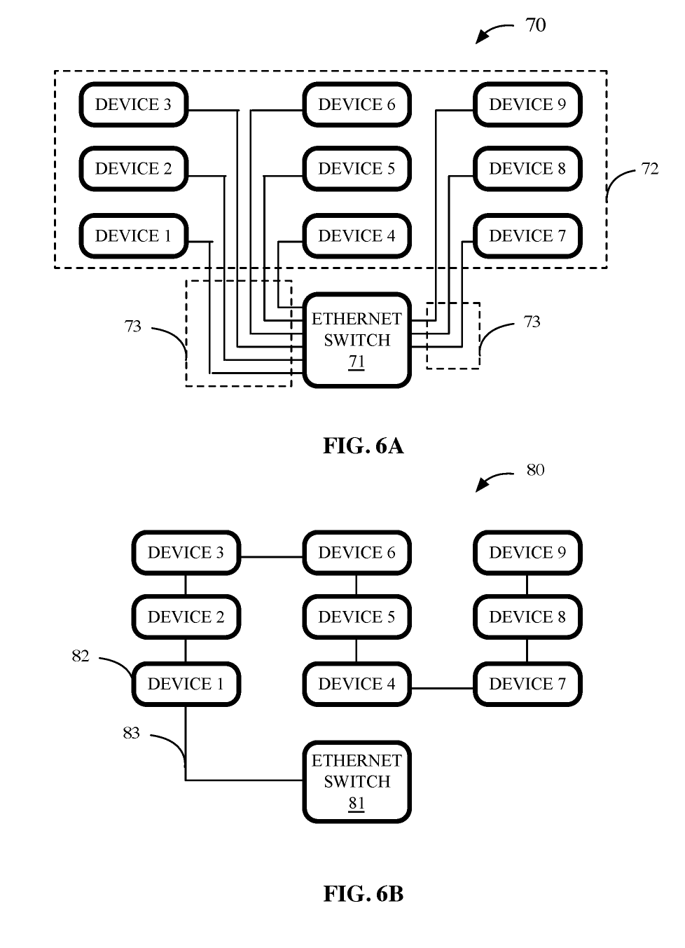

Referring now to FIG. 6A, a star topology 70 network is illustrated. In the star topology, communication cables 73 connect network switch 71 to the networked devices or sensors 72.

Referring now to FIG. 6B, a typical daisy-chain topology, a single cable 83 is run from the network switch 81 to the first sensor 82 in the chain. Subsequent sensors are sequentially chained together with connecting cables. When standard Ethernet network switches are utilized to create ring networks, data packets placed on the network are generally forwarded from one node to the next, circling the ring indefinitely or until their “time-to-live” interval expired. As a consequence, if a large number of data packets are introduced onto a prior art ring network, the amount of traffic on the network would keep increasing until communications slows to a crawl. This is the primary reason that most Ethernet local area networks are configured using a star topology. In a star topology, the nodes at the end of each Ethernet segment will generally either consume the data packet or drop it (rather than forward it) resulting in no paths where the packet can circulate indefinitely.

In some situations, network switches 71 and 81 are a long distance from the associated network devices while the devices are more closely spaced to provide coverage of a more localized area. As a consequence, the connecting cables may be much shorter than the cables that originate at the network switches resulting in much less cabling being required in the daisy-chain topology. As an example, suppose the network switch is approximately 100 meters from the sensors, but the sensors are space only 10 meters apart. In this example, 900 m of cabling would be needed for the star topology, but only 180 m (100 m+8*10 m) for the daisy-chain topology. The cost of installing network cable runs is generally proportional to the length of the cables being run, so the topology can make a big difference in the labor costs needed to run the cables. In addition, with the sensors being powered through the Ethernet cables (POE), any costs associated with running power to the individual sensors is also eliminated.

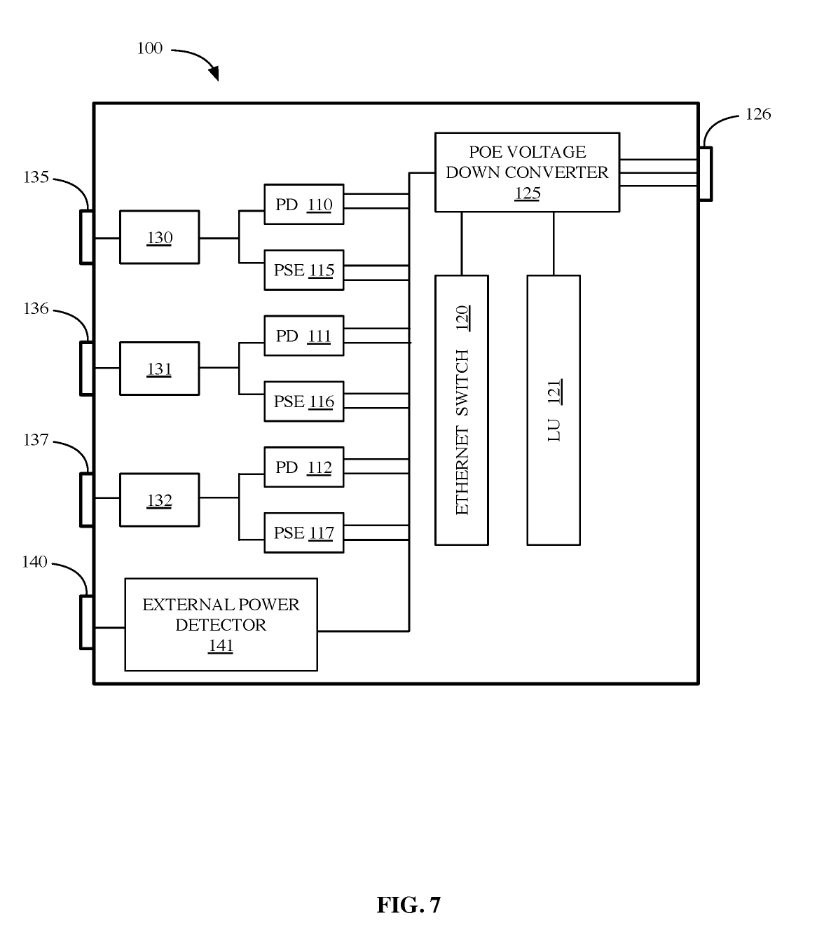

Referring now to FIG. 7 a block diagram of the omni-dexterous POE Ethernet device 100 is depicted. Although the illustration and the following description are for a 3-port device, those skilled in the art will recognize that the invention is not restricted to three ports. 2-port and N-port (where N is greater than or equal to 3) devices may also be implemented using the same fundamental principles discussed herein. Additionally, although the voltage level of the power applied to the Ethernet cables in systems that comply with IEEE 802.3 can fall between 44V and 57V, this disclosure will specify 48V to simplify the discussion. Those skilled in the art will recognize that other voltage levels may be successfully used in various preferred embodiments of the present invention, depending on the specific application environment.

Network device 100 comprises three Ethernet ports 135, 136, and 137, externally connected to other devices communicating using the Ethernet data protocol any of which can be sources of POE power, consumers of POE power, or standard non-POE Ethernet devices such as Ethernet switches, computers, or other Ethernet enabled sensors. The POE signals arriving at ports 135, 136, and 137 is transmitted to transformers 130, 131, and 132. Transformers 130, 131, and 132 separate the data streams from the POE voltages. The data streams are forwarded to multi-port Ethernet switch 120 and Ethernet switch 120 determines which output port the data is to be output on while returning the data stream to one of the transformers 130, 131, or 132. These transformers then recombine the data stream with POE power and send that signal back out through Ethernet ports 135, 136, or 137.

The POE power from transformers 130, 131, and 132 is forwarded on to the internal PD devices 110, 111, and 112. Those PD devices perform a POE handshake with external PSE network devices connected to Ethernet ports 135-137. If the handshake is satisfied, the PDs 110, 111, and 112 power up the internal 48V bus 150. This internal 48V bus supplies power to the POE voltage down converter 125 that converts the 48V signal to a lower voltage, typically 1.8V or 3.3V to power Ethernet switch 120 and logic unit 121.

The 48V signal is also supplied back to the internal PSE devices 115, 116, and 117 that can provide power to external POE PD devices connected to the Ethernet ports 135, 136, and 137. Voltage converter 125 can also supply voltage to non-Ethernet devices that require DC power via voltage connector 126. Also, an external power source can be connected to power port 140. The presence of this external power source is detected by external power detector 141 which signals PDs 110, 111, and 112 to not accept external POE power.

A unique characteristic of this invention relative to the current state of the art is the way the internal PDs and PSEs are configured and controlled. From an external point of view, ports 135, 136, or 137 are functionally identical and, therefore, completely interchangeable. If two Ethernet devices are plugged into two of the ports 135, 136, or 137, the connecting cables can be unplugged and switched around, thereby connecting the two Ethernet devices to different ports with no loss of functionality. The PDs 110-112 and PSEs 115-117 controller circuits and logic unit 121 detect the change and automatically reconfigure voltage and data paths so that the external devices continue to be able to communicate and provide or consume power. Since all ports function in the substantially the same manner, there is no need to label the ports as either “inputs” or “outputs,” where an input port would be connected to a provider of POE power and an output would be a consumer of POE power. This interchangeability of the ports is why the network device of the present invention is termed “omni-dexterous.”

One of the primary benefits of the port flexibility is in its convenience to the user of the network device. Standard Ethernet cables and ports do not have any directionality to them. Consequently, in a device that might have both an input and an output port, it would be easy to make mistakes when wiring the network. With omni-dexterity, the network device automatically detects the ports where power is coming in and configures the other ports to supply power to any attached PoE devices, thereby preventing user mistakes associated with connecting devices to the wrong ports.

An additional benefit accrues from omni-dexterity is that the preferred embodiments of the present invention can be used to set up robust ring or mesh networks of network devices such as sensors.

The adaptability of the ports also allows additional power to be brought to any device in the network where the available power provided by adjacent devices does not meet the local power needs. As an example, if a sensor connected to one of these devices requires more power than is available at the device due to power consumption by upstream sensors, additional power can be provided by plugging a POE injector into one of the ports, or can be provided by plugging in the optional DC power supply. Injecting additional power at one of the devices in a network with a ring topology will be discussed below.

The Ethernet data coming in through ports 135-137 is separated from any potential POE power on the connected Ethernet cables by transformers 130-132. That data is forwarded to the Ethernet Switch 120. The Ethernet Switch 120, is typically implemented as an off-the-shelf, single integrated circuit with a few discrete, passive electronic components. This integrated circuit, either on its own, based on internal logic, or in some embodiments with an attached Logic Unit 121, builds tables of the hardware addresses of the Ethernet data packets that are coming through and determines which of its ports the data packets should be delivered to so that they are delivered to their destination most efficiently. Note that if a Logic Unit 121 is needed to implement the data switching capability, it will be implemented in the form of a microcontroller, and FPGA, or similar device.

Note that if the network is reconfigured by swapping Ethernet cables, or other data paths farther upstream from the device are modified so that the data starts arriving at different ports than in the original configuration, Ethernet Switch 120, possibly in conjunction with the Logic Unit 120, reconfigures, rebuilds its internal routing tables. Consequently, the Ethernet data traffic continues to be delivered to its destination, with a small degradation in performance for a brief period of time during which the routing tables are rebuilt.

The power management aspect of the network device described herein is provided by PDs 110-112, PSEs 115-117 and logic unit 121. Consider the network configuration where POE signal (e.g., power+data) is supplied through a connection to Ethernet port 135. Transformer 130 separates the power from the data before transmitting the power signal to PD 110. External POE equipment (not shown this FIG.) performs the POE handshake with PD 110. When the handshake is successfully completed, the external POE equipment energizes the power provided through Ethernet port 135 to the full 48V POE level. Once PD 110 detects that the full voltage has been applied, it activates a switch that places that power on the internal 48V power bus 142. Once this happens, power is available to POE voltage down converter 125 and to the PSE devices 115-117. Once voltage down converter 125 starts, it provides power to the Logic Unit 121 and the Ethernet Switch 120 allowing them to come online and perform their intended functions.

Note that the PDs 110-112 are typically implemented as integrated circuits with a small number of passive electronic components to set operating conditions. In addition, the switching circuits can be either internal to or external to the primary PD integrated circuit. For the purposes of this device, the PD is any collection of integrated circuits and other electronics that perform the PD side of the POE handshake, activate an electronic switch to connect the external power to the internal 48V power bus, can be disabled through an applied voltage or command, and can signal its operating state to an external device such as the Logic Unit 121.

Once power is available on the internal 48V power bus 142, the PSE devices 115-117 can perform the PSE side of the handshake with external POE/PD devices. If the handshake is properly satisfied, the PSEs 115-117 can close a switch to apply power to the connections on transformers 130-132 providing that power to the external POE/PD devices.

Note that the PSEs 115-117 are typically implemented as integrated circuits with a small number of passive electronic components to set operating conditions. In addition, switch can be internal or external to the PSE IC. For the purposes of this disclosure, the PSE is a collection of integrated circuits and other electronics that perform the PSE side of the POE handshake, activate an electronic switch to connect the power on the internal 48V power bus 142 to the external connections, can be disabled through an applied voltage or command, and can signal its operating state to an external device such as the Logic Unit 121.

Looking at the power connections between the transformer 130, the PD 110, and the PSE 115 shows that the PSE 115 could perform the POE handshake with the internal PD 110. Similarly, for the other device pairs PD 111/PSE 116 and PD 112/PSE117. Because of this internal loopback, each of the PD devices 110-112 and the PSE devices 115-117 must be capable of being disabled as further explained herein. Whenever power is being provided by a particular PD device, the paired PSE device would be disabled while the other PSEs are enabled and their corresponding PDs are disabled. Per our example above, where power is imported by PD 110, PSE 115 would be disable, PDs 111 and 112 would be disabled, and PSEs 116 and 117 would enabled resulting in no corresponding internal PD/PSE pair attempting to handshake with each other or generating an unneeded power loop or power loss.

The signaling capability that the PDs and PSEs must possess in this invention allows the Logic Unit 121 to control which devices are active. When network device 100 is initially activated due to power being applied through one or more of the input ports, the corresponding PDs utilize some of the applied power perform the POE handshake. All of the other devices, including the PSEs 115-117, POE Voltage Down Converter 125, the Ethernet Switch 120, and the Logic Unit 121 are all powered down. Once the PDs that satisfy the POE handshake apply power to the internal 48V power bus 142, the Voltage Converter 125 starts powering up, but the PSEs are configured so that they do not apply power externally. Once the Voltage Converter 125 comes online, the Ethernet Switch 120 and the Logic Unit 121 activate.

The Logic Unit 121 detects which of the PDs 110-112 is receiving external power. The Logic Unit 121 then disables any PD that is not currently transferring power to the internal 48V power bus 142 and all but one of the ones that are transferring power. After a delay allowing the disabled PDs to shutdown properly, the Logic Unit 121 can activate the PSEs 115-117 that correspond to the deactivated PDs.

Note that this logic is simple, so the Logic Unit 121 could be implemented with a small number of logic gates and other discrete electronic components. As discussed below, those skilled in the art will understand that implementing Logic Unit 121 using a general-purpose microprocessor allows for more complex logic needed to reconfigure robust network configurations in applications where parts of the network are subject to failure.

At least one preferred embodiment of the present invention comprises an external power source connected through an optional External Power Port 140. This would typically be a 48V DC power supply. This can be used to provide the 48V POE power in the absence of an external POE Ethernet switch. In addition, for longer runs in the daisy-chained topology shown in FIG. 6, the attached POE sensors could consume sufficient power that sensors farther down the chain would not have the power needed to run them properly. In this situation, the power could be supplemented by applying power through the External Power Port 140 of one of the devices somewhere in the middle of the daisy chain.

Note that whenever power is obtained through the External Power Port 140, none of the PDs 110-112 need to, or should, import power from externally connected devices. Under these circumstances, the External Power Detector 141 signals the Logic Unit 121 to instruct all of the PDs 110-112 to go into their disabled states and all of the PSEs 115-117 to go into their enabled states. That way, the only incoming power is provided through the External Power Port 140 and power can be provided to any of the external devices connected to Ethernet ports 135-137 without generating problematic internal power loops.

Another embodiment of this invention includes exporting external DC power through the Outgoing Power Port 126. The POE Voltage Down Converter 125 can source additional voltage levels that can be exported. Generally, this would be at industrial standard voltages like 3.3V, 5V, 12V, or 24V, but could include other voltage levels. This external power could power devices such as light stacks and sensors such as photoelectric eyes, among many other possibilities.

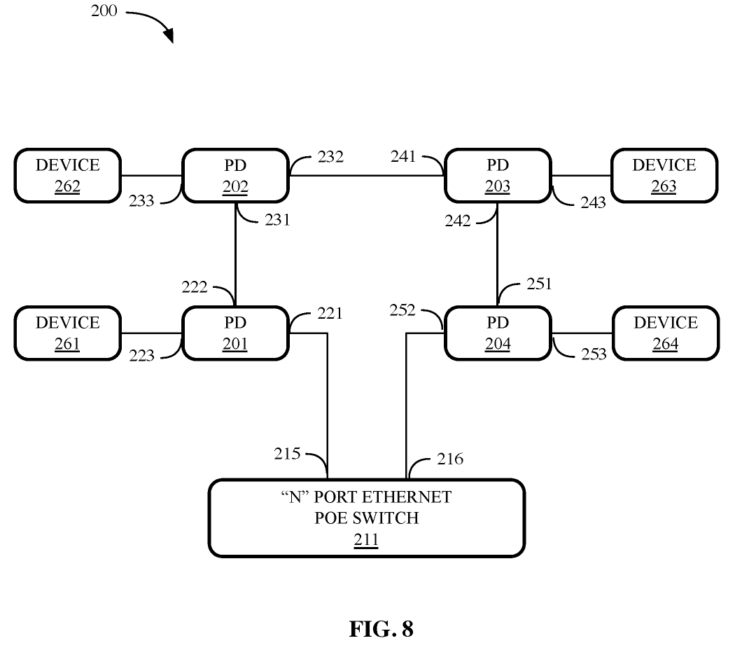

Referring now to FIG. 8, another application for the 3-Port omni-dexterous Ethernet devices 201-204 is illustrated in conjunction with ring network 200. Each of devices 201-204 have three network connection ports and are connected in a ring topology with port 221 of device 201 connected to port 215 of the POE Ethernet switch 211, port 222 of device 201 is connected to port 231 of device 202, and so on until port 252 of device 204 is connected to port 216 of the POE Ethernet switch 211. Also, ports 223, 233, 243, and 253 are connected to either POE or non-POE network devices 261-264.

The primary benefit of a ring topology shown in FIG. 8 is redundancy and robustness relative to a failure in one of the devices or the connections between devices. If a connection or a node fails, there is a backup path for delivering messages to the still active devices in the ring. Note that ring network 200 is connected on each end to different data ports on the POE Ethernet switch 211. As a consequence, data can travel either clockwise or counterclockwise from the data ports 215 or 216 to arrive at a destination device. If a connection or a device should fail, on or the other direction may be the only route whereby a data packet can be delivered to one of the connected devices 261-264.

The 3-Port omni-dexterous Ethernet switch of the present invention solves this problem by disabling one or more of the ports for at least one of the devices in ring network 200. As an example, in configuration shown in FIG. 8, if port 241 of network device 203 is disabled, the ring is “broken,” disallowing any circulating traffic. If device 201 needs to send a data message to device 203, it potentially sends it out on both ports 221 and 222. The message out of port 222 travels to device 202, but since port 241 is disabled, the data packet is dropped. On the other hand, the message sent out on port 221 travels to switch 211 and the data packet is then forwarded on to device 204 which can finally deliver it to destination device 203.

To further illustrate the robustness of this device, if the link between port 242 of device 203 and port 251 of device 204 should fail, data could no longer be delivered to device 203. In that case, the device 203 would recognize the failure of connection to its port 242 and re-enable its port 241 so that there is now an active communication path between network device 202 and network device 203. Now instead of traffic to network device 203 being delivered by communicating with network device 202, it would be delivered via communication with network device 201 and network device 202.

As previously discussed, the most preferred embodiments of the present invention provide for enhanced redundancy relative to data delivery. For POE-based networks, the ring topology also provides data redundancy. As an example, port 215 of the POE Ethernet switch 211 can deliver power to device 201, which can forward it onto device 202. Similarly, port 216 of the POE Ethernet switch 212 can deliver power to device 204 which can forward the power on to device 203. Port 241 on device 203 can be configured so that it neither accepts power from or forwards power to device 202.

As in the data example above, if the connection between devices 203 and 204 should fail, device 203 would no longer be powered. In that case, port 241 on device 203 returns to its default state of receiving power. The PSE associated with port 232 of device 202 periodically attempts to handshake with any devices on the other end of the Ethernet cable attached to that port. Now that port 241 is active, its associated PD responds allowing the power connection between devices 202 and 203 to be established. Once that happens, device 203 powers back up and can deliver data and, potentially, power to the connected sensor 263.

One of the primary difficulties with this, and other more complicated network topologies, is determining which port to disable from both a data and a power perspective. As can be seen from the examples above, once a failure occurs, both the data and the power paths can be reconfigured with little need for additional algorithms or support logic. The initial configuration, however, requires added logic.

In at least one preferred embodiment of the present invention, omni-dexterous Ethernet devices 201-204 of FIG. 8 would disable ports based on the arrival of power on more than one of the Ethernet ports. In the example above, because of time delays inherent in the PSE/PD handshake or other potential issues in the network configuration, power may arrive at port 242 of device 203, and at port 241 before output power can be forwarded through port 241 to port 232 of device 202. Since device 203 was the first device to receive power on both ports, it disables either port 241 or port 242 for both power and data handling.

In one preferred embodiment of the present invention, the choice of which port, either 241 or 242, to disable is made randomly.

In another preferred embodiment of the present invention, the choice of which port to disable is made based on a simple internal numbering scheme. For example, an internal port number 2 is always disabled leaving a second internal port number 1 active.

In another preferred embodiment of the present invention, the choice of which port to disable is based on a measurement of some electrical characteristic, for example, voltage, of the power applied to the competing ports.

In another preferred embodiment of the present invention, the Ethernet switch would disable ports based on a distributed algorithm where the logic units in the switch could communicate with other devices in the network to determine where within the ring to disable connections so that data and power are delivered optimally. Note that in many cases, the data communicated through the Ethernet ports as controlled by the internal N-Port Ethernet switch 120 of FIG. 7 and the power as received by PDs and send by PSEs on each of the Ethernet ports can be separately and selectively enabled or disabled. Consequently, the location within the ring network where the data path is disabled can be different than the location where the power is disabled.

In at least one preferred embodiment of the present invention, the algorithm that determines the optimal place to disable data connections within the network would be based on the Spanning-Tree Protocol (STP), the Rapid Spanning-Tree Protocol (RSTP), Transparent Interconnection of Lots of Links (TRILL), or Shortest Path Bridging (SPB). These algorithms are well-known to those skilled in the art and have been implemented in many enterprise-level Ethernet routers where a similar form of redundancy and automatic reconfiguration are needed. However, these algorithms have not generally been implemented in conjunction with smaller, lower-level Ethernet routers or switches. The computational power needed to implement these algorithms can be quite high requiring more expensive control units adding significant cost to highly cost-competitive products. Also, data outages on the order of 10's of minutes to a couple of hours are generally tolerable in an office environment, so that the robustness to data failures that these algorithms provide are not considered worth the added cost.

Spanning-tree algorithms are generally designed to minimize a cost function across the various possible paths through a network. For the data side of Ethernet networks, the cost function is the amount of time to deliver a data packet from a source device to the destination device (e.g., a time-based algorithm). As an example, in the ring configuration shown in FIG. 8, if all the links between the network devices deliver data at the same rate, the break would be between devices 202 and 203. If, however, the time to deliver data from device 201 to 202 happened to be 100 times slower, the break would be between devices 201 and 202 with the path to 202 being through devices 204 and 203.

In some preferred embodiments of the present invention, the time of travel cost function is used to determine the connection where both the data and power are disabled.

In some preferred embodiments of the present invention, alternative cost functions associated with optimal data delivery are used to disable both the data and power connection link.

In some preferred embodiments of the present invention, a cost function based on the amount of power consumed by the various devices along a network path is used to determine the segment where the power connection is disabled.

In some preferred embodiments of the present invention, the power cost function is determined by measuring the voltage drop along the path, or the amount of current being pulled by the connected devices. As in the data version of the spanning-tree algorithms, where the time of travel cost function is minimized along the various network paths, the power cost function would be minimized along the various network paths.

Note that although the Spanning-Tree Algorithm and the Rapid Spanning-Tree Algorithm are specific algorithms that are utilized in network path optimization, other algorithms are possible to implement where the network ports are to be disabled to prevent data or power collision problems. Also, the cost functions discussed above are purely illustrative in that other cost functions could possibly be used in a cost-function minimization algorithm. The essential ingredient of this algorithmically-based decision-making process is one or more algorithms that can communicate with other devices in the network to choose, independently, where to break the data and the power paths.

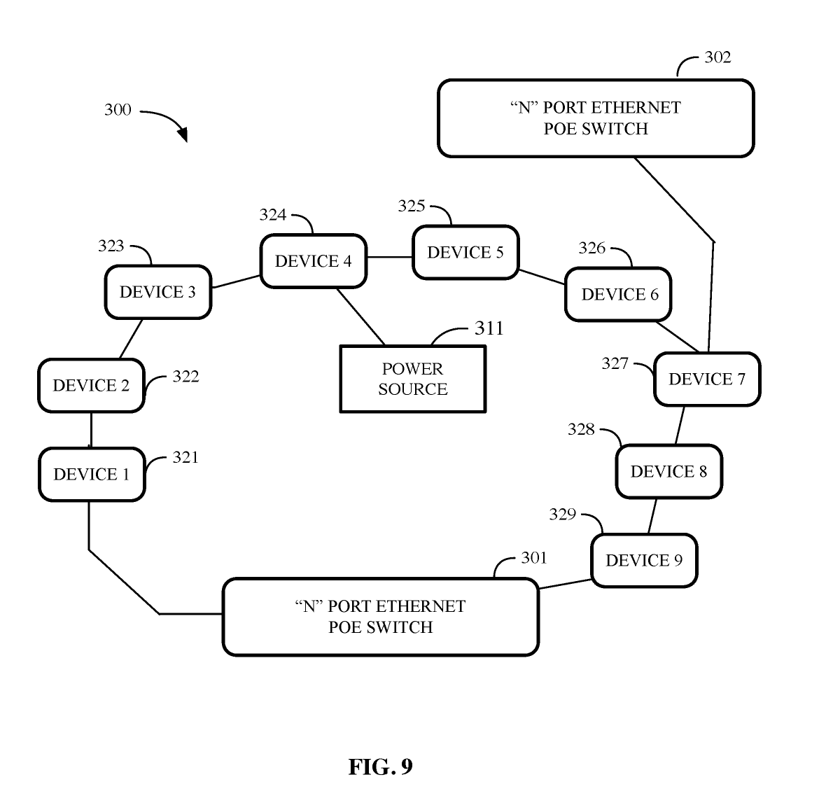

Referring now to FIG. 9, we show an example of a network of 3-port omni-dexterous Ethernet devices 321-329 arranged in a ring topology 300. Data redundancy is provided by the N-Port Ethernet PoE switch 301 being connected to devices 321 and 329 as well as N-Port Ethernet PoE switch 302 connected to device 327. Power redundancy is provided by the N-Port Ethernet PoE switch 301 being connected to devices 321 and 329, by the N-Port Ethernet PoE switch 302 connected to device 327, and by the Power Source 311 connected to device 324.

The primary difference between this example and that of FIG. 8 is in the level of redundancy present. In FIG. 8, we still have one potential single point of failure, the N-Port Ethernet PoE Switch 211. All the power for the devices 201-204 and the data connections to the external network are provided by the PoE Ethernet Switch 211. If it were to fail, all the devices would lose power and would not be able to communicate.

In FIG. 9, there are two N-Port Ethernet PoE switches 301 and 302 available to provide data connections to the external Ethernet network. Now if PoE Ethernet switch 301 were to fail, the devices 321-329 would be able to communicate with the external network through PoE Ethernet switch 302. For example, with switch 301 active, device 322 would send data to device 321 which would subsequently forward it to the switch 301. When switch 301 fails, device 322, would send its data the other way around the loop with its data being forwarded by device 323 to device 324 and so on until device 327 forwards it to the PoE Ethernet switch 302.

Similarly, the two N-Port Ethernet PoE switches 301 and 302 in FIG. 9 are providing power to devices 321-329. If PoE Ethernet switch 302 were to fail, the devices 321-329 would still be able to derive power from a combination of the PoE Ethernet switch 301 and the Power Source 311. Again, as an example of how the power would reconfigure, device 326 would typically derive its power from device 327 which in turn derives its power from the PoE Ethernet switch 302 since that is the shortest path from a power source to the device. If PoE Ethernet switch 302 were to fail, devices 326 and 327 would lose power. In this situation, assuming device 325 had obtained its power from Power Source 311 through device 324, it would still be able to source power and consequently would provide power to device 326. Similarly, device 328 might also lose power depending on whether device 328 derived its power from device 329, or from device 327. If it had derived its power from device 327, device 328 would lose power, but would subsequently reconfigure so that it would derive its power from device 329. Finally, depending on timing and the initial configuration of which devices were powered, device 327 would obtain its power from either device 326 or device 328.

Note that in FIG. 9, we have provided power for part of the ring of devices 321-329 through Power Source 311. This power source provides redundancy for providing power to the network if one of the devices providing power were to fail. It serves an additional purpose as well. Each of devices 321-329 consumes some power. It is quite likely that the device or devices farthest from a source of power would not have enough power to function properly. For example, in FIG. 9, without the Power Source 311, device 324 would be 3 hops away from a power source on either of its ports. If all the devices 321-327 consumed the same amount of power, device 324 would have the least amount of power available from either direction. Consequently, device 324 would be the one most likely to need supplemental power. Power Source 311 has been connected to device 324 in FIG. 9 to provide the supplemental power that might be needed.

Note that Power Source 311 could be provided by a PoE Ethernet injector, by another N-Port PoE Ethernet Switch, or by an auxiliary AC or DC external power supply.

In at least one preferred embodiment of the present invention, the capability, functionality, or “behavior” of each of the various ports can be characterized by each port's ability to send or receive power and by each port's ability to send or receive data. Preliminarily, each port is configured to send and receive data. However, once a power source is connected to a port, that port can be dynamically configured to receive power from the power source and to then supply power to other ports and, in turn, to one or more external devices connected to the other ports.

From the foregoing description, it should be appreciated that the various preferred embodiments of the POE network device disclosed herein presents significant benefits that would be apparent to one skilled in the art. Furthermore, while multiple embodiments have been presented in the foregoing description, it should be appreciated that a vast number of variations in the embodiments exist. Lastly, it should be appreciated that these embodiments are preferred exemplary embodiments only and are not intended to limit the scope, applicability, or configuration of the invention in any way. Rather, the foregoing detailed description provides those skilled in the art with a convenient road map for implementing a preferred exemplary embodiment of the invention, it being understood that various changes may be made in the function and arrangement of elements described in the exemplary preferred embodiment without departing from the spirit and scope of the invention as set forth in the appended claims.

1. A device comprising:
a plurality of ports wherein each of the plurality of ports is configured to send and receive at least one data signal, and wherein at least one of the plurality of ports can be dynamically configured to either send a power signal or to receive a power signal; and
a logic controller unit, the logic controller unit dynamically configuring at least one of the plurality of ports to either send or receive power from a power source.

2. The device of claim 1 further comprising an Ethernet switch.

3. The device of claim 1 where at least one of the plurality of ports is configured to either send or receive power from a power source when the device is not powered.

4. The device of claim 1 wherein the logic controller unit detects power being applied to at least one of the plurality of ports.

5. The device of claim 1 wherein the logic controller unit is configured to detect when at least one port of the plurality of ports is configured to send power and further detect when the at least one port of the plurality of ports is actively sending power to an external device connected to the at least one port of the plurality of ports.

6. The device of claim 1 wherein the logic controller unit selectively configures at least of the plurality of port to send power or to receive power based upon at least one of: an external instruction provided to the device; or power consumption.

7. The device of claim 1 further comprising a circuit that dynamically reconfigures the plurality of ports to send an external power signal to at least one external network device that has been configured to receive an external power signal.

8. The device of claim 1 further comprising:
a first power source supplying power to the device; and
a circuit coupled to the device, the circuit being configured to supply power from a second power source to at least one of the plurality of ports if power from the first power source is not delivered to the device.

9. The device of claim 1 further comprising a plurality of additional network devices wherein at least one of the plurality of additional network devices is powered by a dedicated power source and wherein each of the plurality of additional network devices are controlled by a logic controller unit and wherein the logic controller units for the plurality of additional network devices dynamically reconfigures a plurality of ports associated with the plurality of additional network devices in response to a failure of a dedicated power source supplied to at least one of the plurality of additional network devices, thereby restoring partial or total operational capability for the plurality of additional network devices.

10. The device of claim 9 wherein at least one ports associated with the plurality of additional network devices is dynamically configured to either send or receive a distributed power signal in order to optimize power distribution amongst the plurality of additional network devices.

11. A network connectivity device, the network connectivity device comprising:
a logic controller unit; and
a plurality of ports coupled to the logic controller unit, wherein each of the plurality of ports is configured to send and receive data signals and wherein at least one of the plurality of ports can be dynamically configured to either send or receive power.

12. A method of providing power and data to a network, the method providing the steps of:
monitoring a device, the device comprising:
a plurality of ports, wherein each of the plurality of ports is configured to send and receive data; and
a logic controller unit;
connecting a power source to at least one of the plurality of ports, thereby creating a connected port;
using the logic controller unit to detect the power source connected to the connected port; and
using the logic controller unit to dynamically configure the connected port to supply power from the power source to at least one other port selected from the plurality of ports.

13. The method of claim 12 wherein at least one of the plurality of ports is configured with a default setting to receive power from the power source.

14. The method of claim 12 wherein the logic controller unit is configured to detect which of the plurality of ports is connected to the power source.

15. The method of claim 12 further comprising the step of using the logic controller unit to disconnect any power receiving circuitry from any port other than the connected port.

16. The method of claim 12 wherein the step of connecting a power signal to at least one of the plurality of ports comprises the step of providing power from the power source to at least two ports selected from the plurality of ports.

17. The method of claim 12 wherein the logic controller unit detects the power signal and dynamically configures at least two of the plurality of ports to send the power signal to at least two external devices.

18. The method of claim 12, further comprising circuitry is used to allow multiple ports to receive power from multiple external sources despite that external sources being either electrically floating or associated with different electrical ground potentials.

19. The method of claim 12 wherein the logic controller unit is configured to dynamically configure the power behavior of each of the plurality of ports as one of: a power signal receiving port or a power signal sending port; and the data behavior of each of the plurality of ports as a data signal receiving port; a data signal sending port; or a data signal sending and receiving port.

20. The method of claim 12 wherein the logic controller unit is configured to maximize power and data distribution using a configuration for the plurality of ports based on an algorithm.

21. The method of claim 20 wherein the algorithm is at least one of: a time-based algorithm; a distance based algorithm; a voltage based algorithm; a spanning-tree algorithm; and a rapid spanning-tree algorithm.
